(19) United States
(12) Patent Application Publication
(10) Pub. No.: US 2005/0013915 A1
(43) Pub. Date: Jan. 20, 2005

(54) Mixtures with a sweetness and taste profile of high fructose corn syrup (HFCS) 55 comprising HFCS 42 and acesulfame K

(76) Inventors: William E. Riha, Somerset, NJ (US); Eduardo-Ignacio Molina-Cortina, Puente Colorado (MX)

Correspondence Address: ProPat, L.L.C., 2912 Crosby Road, Charlotte, NC, 28211-2815, US

(21) Appl. No.: 10/618,794

(22) Filed: Jul. 14, 2003

(51) Int. Cl. A23L 1/236

(52) U.S. Cl. 426/548

(57) ABSTRACT

The invention relates to a mixture with a sweetness and taste profile of HFCS 55, which mixture comprises HFCS 42 and 0.015-0.035 wt % (based on the weight of HFCS 42) of Acesulfame K.

### BACKGROUND OF THE INVENTION

High fructose corn syrups are isomerized corn syrups derived from the isomerization of glucose in the syrup to fructose by the enzyme isomerase. In certain regions syrups with levels of 42% fructose and 55% fructose are mainly used in beverages instead of sugar for cost reasons. It is well accepted that the taste quality of HFCS 55 is superior to HFCS 42 and that both taste profiles are different with respect to sucrose. HFCS 55 can be regarded as sweetness standard in certain region and product categories.

High intensity sweeteners are synthetic or natural substances, which have no or virtually no calories and a sweetness potency several times higher than sugar. High intensity sweeteners or blends of high intensity sweeteners are used in food and beverages to achieve a sweet taste without adding calories to the products. High intensity sweeteners commonly used are acesulfame K, alitame, aspartame, cyclamate, lo han go, neohesperidine dihydrochalcone, neotame, saccharin, stevioside and sucralose.

However, no high-intensity sweetener matches the taste profile of HFCS 55 completely. They differ in characteristics such as sweetness profile, side taste and off-taste characteristics. Proper blending of different high intensity sweeteners is known to overcome part of the taste limitations of single high-intensity sweeteners. But even if a more HFCS 55-like sweetness profile is achieved in products with high-intensity sweeteners only, they still can be distinguished sensorically from their counterparts with just HFCS 55 by lack of mouthfeel and reduced flavour characteristics.

### PRIOR ART

Fry (Sugar replacement in non-diet soft drinks, Food Technology International Europe, 83-86, 1995) describes 30 and 50% calorie reduced sweetening concepts in cola and lemonades using combinations of either glucose sirup and aspartame or low-fructose syrups and aspartame. Using a consumer panel it was shown that the taste profile of none of these sweetening systems was similar to sucrose. In fact the glucose syrup/aspartame and low-fructose syrup aspartame mixtures showed statistically significant differences in sweetness, acidity, sweet aftertaste, bitter aftertaste, length of aftertaste, liking for aftertaste, mouthfeel, odour liking, flavour liking and overall liking.

Simon (Simon et al., Combinations of glucose syrups and intense sweeteners, application in calorie reduced soft drinks. In 'FIE. Food ingredients Europe. Conference proceedings, Paris 27, 28, 29 September 1989′. Maarssen, Netherlands; Expoconsult Publishers, 330-333, 1989) recommends using 3% glucose syrup and different combinations of high-intensity sweeteners, which are calculated from a computer model without giving any sensory description of their taste profiles compared to sugar.

Lotz and Meyer (Lotz, A., Meyer, E.: Sweeteners in beverages—New developments, Food Marketing & Technology, 4-91,1994.) recommend recipes using sugar and sweetener blends stating that these combinations create a “nicely balanced sweetness” without showing any sensory results compared to sugar.

Thus, no proper blending of high intensity sweeteners alone or mixtures with HFCS 42 are known, which matches the taste profile of HFCS 55 sufficiently.

It was therefore an objective for the present invention to develop a mixture based on HFCS 42 having a taste profile similar to HFCS 55. Such mixtures would have an economic advantage over HFCS 55 compositions since HFCS 42 is cheaper than HFCS 55 and as long as the amount and price of the high intensity sweetener which has to be used to match the HFCS 55 profile together with the price for HFCS 42 stays below the HFCS 55 price.

### BRIEF DESCRIPTIONS OF THE INVENTION

The present invention, therefore, relates to a mixture with a sweetness and taste profile of HFCS 55, which mixture comprises HFCS 42 and 0.015-0.035, preferably 0.022-0.032, especially preferred 0.026-0.030 and even more preferred 0.027-0.029 wt % (based on the weight of HFCS 42) of Acesulfame K.

### DETAILED DESCRIPTION OF THE INVENTION

Although Acesulfam K and blends of Acesulfame K with other high intensity sweeteners such as Aspartame or Sucralose do not match the taste profile of HFCS 55, surprisingly it was observed that mixtures of HFCS 42 and specific amounts of Acesulfame K have a taste profile which is not significantly different from HFCS 55.

These HFCS 42 mixtures can be used in e.g. beverages. Suitable beverages according to the invention are all alcoholic beverages and non-alcoholic soft drinks, carbonated or non-carbonated. Examples of these are cola, orangeades, lemonades, iced tea drinks, aromatized mineral water, energy drinks, sports drinks, fruit juice drinks and fruit juices.

The mixtures may also contain minor amounts, i.e. up to 10 wt.-%, preferably up to 5 wt.-% of commonly used additives such as flavours, bulking agents weighing agents etc.

The mixture is prepared by simply mixing HFCS 42 with Acesulfame K.

The invention is further illustrated by the following, non limiting, examples.

### EXAMPLES

Methodology

Descriptive Analysis Tactic: Consensus method
Respondents: Eight trained descriptive analysis profile panellists.
   Procedure:

Panellists tasted the following basic tastes prior to developing their consensus judgments of the samples: Sweet 15, Bitter 2, Sour 2 and Chem 3. Panellists were told that the samples were “Corn Syrup Diluted in Water” and that consensus flavour profiles were needed for a Warm Up sample and five test samples. No further information was provided to the panellists about the nature of the samples. HFCS-55 served as the warm up sample.

Definitions:

| Term | Definition |
|---|---|
| Sweet | The basic taste associated with sucrose. |
| Bitter | The basic taste associated with caffeine. |
| Sour | The basic taste associated with citric acid. |
| Throat Burn | The sensation of burning at the back of the throat as a |
| | product is swallowed. |
| Chemical | The general perception of a chemical characteristic, |
| | giving a “flat” taste, does not include medicinal or |
| | antiseptic. |

All samples were blind coded with three digit numbers, served in a 2-Solo cup and tasted at room temperature.

### EXAMPLES

Products:
(1) HFCS-42 DE—Lot # 3HD209 Arancia Corn Products (Mexico) 100 g of HFCS 42+900 g spring water
(2) HFCS-42 DE—Lot # 3HD209 Arancia Corn Products (Mexico) 0.008 g Acesulfame K+100 g of HFCS42+900 g spring water
(3) HFCS-42 DE—Lot # 3HD209 Arancia Corn Products (Mexico) 0.012 g Acesulfame K+100 g of HFCS42+900 g spring water
(4) HFCS 42 DE—Lot. # 3HD209 Arancia Corn Products (Mexico) 0.028 g Acesulfame K+100 g of HFCS42+900 g spring water
(5) HFCS-55 55 DE Lot. # 3HD504 Arancia Corn Products (Mexico) 100 g of HFCS55+900 g spring water
   Results:

The consensus results are shown below in Table 1.

TABLE 1

| | | HFCS-42 + .008 g | HFCS-42 + .012 g | HFCS-42 + .028 g | |
|---|---|---|---|---|---|
| Attribute | HFCS-42 | Acesulfame K | Acesulfame K | Acesulfame K | HFCS-55 |
| Sweet | 7.4 | 6.8 | 6.9 | 8.2 | 8.6 |
| Bitter | — | 2.2 | 2.1 | 2.0 | 2.5 |
| Sour | — | — | — | — | — |
| Throat Burn | — | — | — | — | — |
| Mouthdry | 3 | — | 2.7 | 2.3 | 2.7 |
| Off-Note | 3.1 | Metallic/ | Metallic/ | 3.0 | |
| | Metallic/ | Lingering | Chem | Metallic/ | |
| | Chem | sweet | | Chem | |

*All ratings were done on a 15 cm unstructured line scale where a “0” meant none of the attribute was present and a “15” meant that the attribute was very intense. “Low” intensity ratings are in the range of 0-moderate intensity ratings are in the 5-10 range and high intensity ratings in the range of 10-15.
**In order to consense on an attribute, panellists needed at least four responses, a majority of the seven. When 3 or fewer panellists found the attribute present, it was not considered part of the sample's profile.

Consensus ratings that are at least one intensity point different are considered evidence to support a difference in the products, perceivable by highly sensitive panellists.

As can be seen in Table 1 above, the HFCS-55 and the HFCS-42+0.028 g Acesulfame K samples were rated as equal in sweet intensity. The flavour profiles of these two samples look similar in all other attributes.

The 0.008 and 0.012 g added Acesulfame K samples were similar to the HFCS-42 sample in all measured attributes.

Graph 1 shows the flavour profile of the five samples tested.

The flavour notes associated with high intensity sweeteners, “Metallic, “Chem,” were perceived at very low levels in all of the HFCS-42 samples. Because these ratings of “Chem” were so low, and attributed to a sample with no Acesulfame K added at all, these “Chem” ratings may reflect the panellists' uncertainty as to the presence/absence of “Chem.” Overall, if these panellists are uncertain if there is Chem present in the samples, they tend to err on the side of saying there is Chem present when in fact it is not.

Conclusions:

The sample with 0.028 g Acesulfame K added to HFCS-42 was rated as equally sweet as compared to the HFCS-55 sample. The flavour profiles of these two samples 0.028 g Acesulfame K+HFCS-42 and HFCS-55 were virtually identical in all other sensory attributes.

Manufacturers can realize substantial cost savings if this blend of sweeteners is utilized in existing formulations.

The HFCS-42 was rated as less sweet than the HFCS-55. On a blind basis, highly trained panellists rated the sweetness of HFCS-42 lower in intensity than HFCS-55. Otherwise, the flavour profiles of HFCS-42 was very similar to that of HFCS-55 on all other attributes.

Adding Acesulfame K to the HFCS-42 at the 0.008 g/100 g corn syrup solution and 0.012 g/100 g corn syrup solution level did not increase the perceived sweetness of the solution to match the sweetness of HFCS-55, or change the flavour profile in any substantive way. Apparently, to increase the sweetness of HFCS-42 to match that of HFCS-55, Acesulfame K must be added at levels greater than 0.012 g/100 g corn syrup solution.

Use added Acesulfame K to at least the 0.028 g/100 g level to boost the sweetness of HFCS-42 to match the sweetness of HFCS-55. The trace levels of high intensity sweetener flavour notes detected by these eight highly trained panellists are so low that consumers tasting HFCS+Acesulfame K blends, especially in a product, would very likely taste only the corn syrup flavour notes.

Adding Acesulfame K to the samples at the levels used in the Examples did not add flavour notes associated with high intensity sweeteners.

[image]

1. A mixture with a sweetness and taste profile of HFCS 55, which mixture comprises HFCS 42 and 0.015-0.035 wt % (based on the weight of HFCS 42) of Acesulfame K.

3. Mixture according to claim 1, wherein the mixture comprises 0.022-0.032 wt.-% of Acesulfame K.

4. Mixture according to claim 1, wherein the mixture comprises 0.026-0.030 wt.-% of Acesulfame K.

5. Mixture according to claim 1, wherein the mixture comprises 0.027-0.029 wt.-% of Acesulfame K.

6. Beverage comprising a Mixture according to claim 1.
